(19) United States
(12) Patent Application Publication
(10) Pub. No.: US 2005/0199024 A1
(43) Pub. Date: Sep. 15, 2005

(54) Motor vehicle door locking means

(75) Inventor: Rainer Wirths, Wuppertal (DE)

Correspondence Address: NIXON PEABODY, LLP, 401 9TH STREET, NW, SUITE 900, WASHINGTON, DC, 20004-2128, US

(73) Assignee: Brose Schliesssysteme GmbH and Co. KG, Wuppertal (DE)

(21) Appl. No.: 11/071,460

(22) Filed: Mar. 4, 2005

(30) Foreign Application Priority Data
Mar. 5, 2004 (DE) 10 2004 011 650.4

(51) Int. Cl. B60R 25/00

(52) U.S. Cl. 70/237

(57) ABSTRACT

A motor vehicle door locking arrangement and a motor vehicle lock for mounting on a motor vehicle door and an associated method of installation. The locking arrangement includes a motor vehicle door lock including an attachment arrangement, a door handle, and a linkage for a connecting the door handle to the motor vehicle door lock. The linkage transmits actuating forces, created by actuation of the door handle, to the motor vehicle door lock, and wherein the attachment means and the linkage connected relative to the movements caused by actuation of the door handle. The attachment arrangement has an opened position in which the linkage can be freely moved in at least one direction relative to the attachment arrangement, and a closed position in which the linkage is fixed relative to the attachment arrangement, with respect to the movements caused by actuation of the door handle.

### BACKGROUND OF THE INVENTION

1. Field of Invention

The present invention relates to a motor vehicle door locking means for a motor vehicle door lock, a motor vehicle door lock and associated method for installation of a motor vehicle door locking means.

2. Description of Related Art

Motor vehicle doors generally have a door module on which various functional parts and attachments, such as a window raiser, door lock, door handle, speaker, etc., are mounted. The motor vehicle door lock is often mounted on a door module. When the door handle is mounted on the door module, a dynamic connection between the door handle and motor vehicle door lock is produced via a linkage. When the door handle is actuated, the motor vehicle door lock, i.e., a corresponding actuation element of the lock mechanism of the motor vehicle door lock, is actuated. The linkage can be, for example, a rod which is connected to the motor vehicle door lock. The attachment between the motor vehicle door lock and the linkage of the door handle can be made such that installation tolerances can be equalized.

A known motor vehicle door locking means, as provided in German Patent Application DE 197 48 021 A1, is made such that the establishment of a dynamic connection between the linkage and the motor vehicle door lock during installation is easily possible. In the motor vehicle door locking means the door handle is premounted on the door module. The motor vehicle door locking means is made such that, by a defined shifting of the motor vehicle door lock in installation on the door module, a dynamic connection is produced between the linkage of the door handle and the motor vehicle door lock. For this purpose, on the motor vehicle door lock an attachment means is provided such that the attachment means itself becomes dynamically connected to the linkage when the motor vehicle door lock is shifted.

The disadvantage of such a system is that equalization of the tolerances which are necessary for installation is only possible within narrow limits. The narrow limits are established by the fact that the motor vehicle door locking means is to be reliably and securely installed in spite of tolerance equalization. As a result, a considerable initial idle stroke occurs when the door handle is actuated.

Another motor vehicle door locking means, provided in European Patent Application EP 0 400 505 A1, is completely premounted. In other words, the door handle, the motor vehicle door lock, and linkage are already connected to one another comprising a door lock module prior to installation. The connection is attained by a rigid, L-shaped carrier. Here, the linkage of the door handle to the motor vehicle lock can be easily adjusted beforehand. But the problem is that when this motor vehicle door locking means is installed in a motor vehicle door, a large amount of space is required to move the large door locking means into its installation position. Moreover, this construction requires high production precision of the shell of the motor vehicle door.

This problem has already been recognized and solved. In a motor vehicle door locking means provided in European Patent EP 0 508 580 B1, the installation of the motor vehicle door locking means is simplified in that the carrier for the door handle, the linkage and the motor vehicle door lock are flexible. This door lock module with a flexible carrier can be moved more easily into the installation position in the motor vehicle door. In any case, this also requires a flexible linkage from the door handle to the motor vehicle door lock. However, the problem of tolerances and of the initial idle stroke or of the necessity of final adjustment on the belt are also present.

In the motor vehicle door locking means, disclosed in European Patent Application EP 0 229 885 A2, which forms the starting point of the present invention, the linkage is a rod which is inserted into an attachment means of the motor vehicle door lock which is already attached to the front sheet metal of the motor vehicle door. The attachment means is made such that by inserting the linkage into the attachment means, a dynamic connection between the linkage and the motor vehicle door lock is produced. For this purpose, the linkage locks upon insertion in the attachment means. However, the locking of the linkage prevents from being able to be pulled back again. However, deeper insertion of the linkage is not precluded so that the linkage can be inserted into the attachment means to the extent necessary in installation. Thus, the undesirable idle stroke of the door handle can be reliably eliminated.

The disadvantage of such a system is that positioning of the linkage, and thus of the door handle, is complex. Readjustment is possible only to a limited degree since the motion of the linkage is very limited as soon as the linkage is inserted a distance into the attachment means. Additionally, it is also disadvantageous in that the door handle and the linkage of the door handle must be installed from the outer side of the door through employment of a specific installation sequence. In particular, first of all the motor vehicle door lock must be definitively fixed. Only afterwards can be door handle be mounted. Readjustment of the motor vehicle door lock when the door handle is already in the end position is not possible or is only possible with difficulty.

### SUMMARY OF THE INVENTION

The present invention provides a motor vehicle door locking means for a motor vehicle, and a corresponding motor vehicle door lock which is optimized with respect to installation, and an installation process for the motor vehicle door locking means.

The aforementioned object is achieved by providing an attachment means for a motor vehicle door lock of a motor vehicle door locking means having two different positions. It is provided, first of all, that a linkage, with the attachment means opened, can be freely moved in at least one direction relative to the attachment means. In this way it is possible for the linkage and the motor vehicle door lock to be moved relative to one another as long as the attachment means is not closed. As a last step in the installation of the motor vehicle door locking means, the attachment means, which has been open until then, is closed. Only then is the linkage relative to the attachment means fixed in the attachment means and the secure connection of the door handle to the motor vehicle door lock provided. As a result, the corresponding actuating element of the lock mechanism of the motor vehicle door handle, is established. Thus, a tolerance-free connection of the door handle to the motor vehicle door lock is accomplished, readjustment is not necessary, and an idle stroke is systematically excluded.

It is advantageous for installation if the attachment means has an opening into which the linkage can be inserted, and with a diameter which is greater than the diameter of the linkage. In this way, the linkage is already guided in the attachment means without the movement of the linkage being limited to such an extent that equalization of tolerances would no longer be possible. The opening, as much as possible, should be funnel-shaped or conical, so that the linkage need not be exactly aligned to the opening upon insertion.

Another aspect of the present invention is to provide the attachment means as a clip since, closing of a clip is simple and can be implemented in various ways. Furthermore, it is advantageous if the motor vehicle door locking means is made such that an additional installation step is not necessary to close the attachment means. Instead, it would be advantageous if placement of the attachment means in the closed position is a secondary function of other installation steps and takes place essentially “by itself”.

Advantageously, the closing of the attachment means can also take place by means of an auxiliary element which is a pivotally supported component and which interacts with the attachment means. It is especially advantageous if the auxiliary element is the latch of the motor vehicle door lock itself and the attachment means can thus be closed by the first-time closing of the motor vehicle door.

Another exemplary embodiment of the present invention is directed to placing the attachment means in the closed position (i.e., closing the attachment means) and includes carrying out a closing process by means of an auxiliary element, which is an attachment element, and which is used at the same time for attachment of the motor vehicle lock itself to the motor vehicle door. It is especially advantageous if the attachment means is the last attachment element which is necessary for attachment of the motor vehicle lock.

The present invention is explained in detail below using the drawings with reference to the preferred embodiments. In the course of these explanations, other embodiments and developments and other features, properties, aspects and advantages of the invention are explained at the same time.

### BRIEF DESCRIPTION OF THE DRAWINGS

FIG. 1 schematically shows a motor vehicle door locking means in accordance with an exemplary embodiment of the present invention,

FIG. 2 shows a schematic of the motor vehicle door lock in the opened position,

FIG. 3 shows the motor vehicle door lock from FIG. 2 in the closed position,

FIG. 4 shows another execution position of the motor vehicle door lock in the opened position, and

FIG. 5 shows the motor vehicle door lock from FIG. 4 in the closed position.

### DETAILED DESCRIPTION OF THE INVENTION

In the figures, the same reference numbers are used for the same or similar parts from version to version. This is intended to indicate that the corresponding or comparable properties and advantages are achieved.

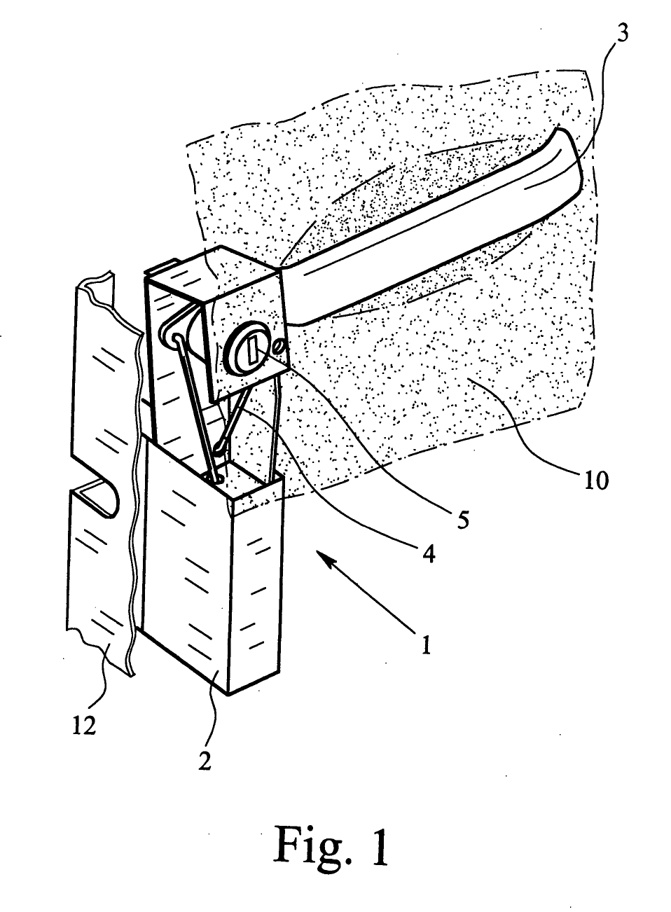

FIG. 1 shows a motor vehicle door locking means 1 with a motor vehicle door lock 2, a door handle 3 and a linkage 4 of the door handle 3. Motor vehicle doors for the purposes of the present invention can include side doors, rear doors and rear hatches of motor vehicles, or the like. The linkage 4, which is preferably a rod, is used to establish a connection between the door handle 3 and the motor vehicle door lock 2, so that the actuating forces created by actuation of the door handle 3 are transmitted to the motor vehicle door lock 2 and that vehicle door lock 2 can be opened by actuation of the door handle 3. The illustrated embodiment shows the door handle 3 as an outside door handle. With these types of door handles, a specific problem associated with idle stroke is especially prevalent, due to the manner of installation.

It should be understood that, instead of the door handle 3, a similar construction to that described above could also be employed for a lock barrel 5. In this case, a linkage 4 can be used for connection of the lock barrel 5 to the motor vehicle door lock 2.

The motor vehicle door lock 2 has an attachment means 6 for the linkage 4. The motor vehicle door lock 2 and the linkage 4 can be connected to one another by the attachment means 6 such that movement of the linkage 4, which is caused by actuation of the door handle 3, is transmitted to the attachment means 6. The attachment means 6 is, in turn, connected to the actuating element of the motor vehicle door lock 2 such that the motion of the linkage 4 leads to motion of the actuating element. Thus, opening of the motor vehicle door is enabled.

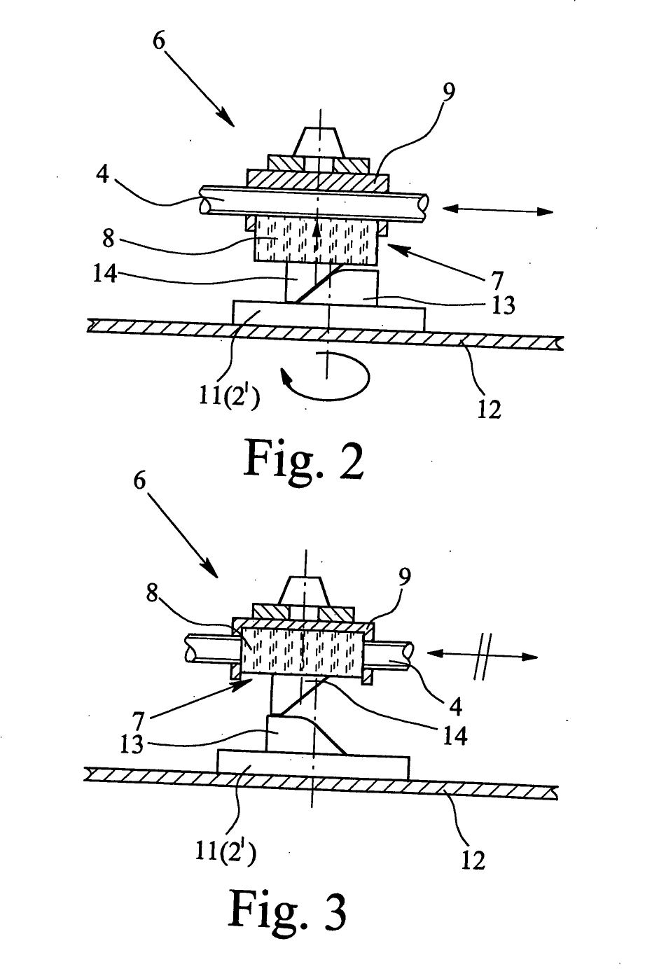

The attachment means 6 has an opened position (FIGS. 2 & 4) and a closed position (FIGS. 3 & 5). When the attachment means 6 is opened, the linkage 4 can be freely moved, relative to the attachment means 6 in the direction of the double arrow. With the attachment means 6 closed (i.e., in the closed position), the motion of the linkage 4 relative to the attachment means 6 in the direction of the double arrow, is stopped. Motion of the linkage 4 is then possible only together with the attachment means 6.

The attachment means 6, in accordance with an exemplary embodiment of the present invention, is made so that the linkage 4 can be inserted into the attachment means 6 when the attachment means 6 is in the opened position. The attachment means 6 can be made such that the linkage 4 is guided in it, but motion is possible not only in the direction of the double arrow, but also to a limited degree transversely to this direction. Moreover, the attachment means 6, on the side on which the linkage 4 is inserted, has an opening which can be made in a conical or funnel-shaped manner, or the like. The linkage 4, during installation, need not be aligned exactly to the opening of the attachment means 6.

The connection of the linkage 4 to the attachment means 6, in the closed position, is preferably achieved by a clamping connection 7. However, instead of the clamping connection 7, an adhesive connection, or the like, can also be employed. An adhesive connection can be made, for example, such that a cement is applied to the linkage 4, coated with a protective layer. The protective layer is then removed when the attachment means 6 is closed so that the cement takes effect between the linkage 4 and the attachment means 6.

Also, a clamping connection 7 can be achieved, for example, when a screw or the like is pressed against the linkage 4 out of the attachment means 6. A more suitable method shown herein is use of a clip. The clip has a bottom part 8 and a top part 9. In the opened position of the attachment means 6 the clip is opened, while in the closed position of the attachment means 6 it is closed around the linkage 4 and squeezes against it.

Instead of a purely non-positive connection between the linkage 4 and the attachment means 6, the linkage 4 and attachment means 6 can also be made such that they are positively connected to one another. This can be accomplished, for example, in that the linkage 4 is a threaded rod and the bottom part 8 of the clip and/or the top part 9 of the clip has an inside thread which can engage the threaded rod. This shape of the connection optimizes the transmission of force between the linkage 4 and the attachment means 6.

If the door handle 3 is an outside door handle, the door handle 3 is normally attached to the outside sheet metal of the motor vehicle door. However, there are also other types of attachment. For example, door handles can also be situated in a framed door, in an extension to the frame capping piece or above the outside sheet metal 10 of the door to the surround of the window frame.

For installation of the motor vehicle door locking means 1 it is especially advantageous if the attachment means 6 is closed by a first-time closing of the motor vehicle door. This can be done, for example, by an auxiliary element 11 being made and arranged such that it acts on the attachment means 6 when the motor vehicle door is being closed, and thereby placing the attachment means in the closed position.

In the embodiment shown in FIGS. 2 & 3, the auxiliary element 11 is the latch 2′ of the motor vehicle door lock 2. However, it should be known that the auxiliary element 11 can also be another pivotally supported component. It is advantageous in the embodiment shown that the latch 2′ pivots when the motor vehicle door is being closed, so that it is possible to have the attachment means 6 closed by the first-time closing of the motor vehicle door. In this way, it is ensured that the closing of the attachment means 6, and thus establishing a secure connection from door handle 3 to the motor vehicle door lock 2, takes place only when complete installation of all parts in the motor vehicle door has been finished. As the motor vehicle door is closed, the latch 2′ turns into the main locking direction and is held by a ratchet there. This rotation closes the attachment means 6 and fixing of the linkage 4 of the door handle 3 in the motor vehicle door lock 2 is completed.

In the embodiment shown, the auxiliary element 11, which is a latch 2′, acts on the attachment means 6, which is a clip. The bottom part 8 of the clip is pushed into the top part 9 of the clip so that the clip is closed. The auxiliary element 11 is attached preferably to the front sheet metal 12 of the door, via the attachment of the motor vehicle door lock 2.

The auxiliary element 11 in the embodiment shown has a ramp 13. The attachment means 6 also has a ramp 14, and the bottom part 8 of the clip is located on the top of the ramp 14. The ramps 13, 14 are located opposite one another. The ramps 13, 14 are arranged and made such that when the auxiliary element 11, and thus also the ramp 13, turn with one another in the manner of a key drive, the ramps interact. The bottom part 8 of the clip is pushed up by the rotation of the ramp 13 (FIG. 3) and engages the top part 9 of the clip. In this way the linkage 4 is squeezed and fixed in the attachment means 6.

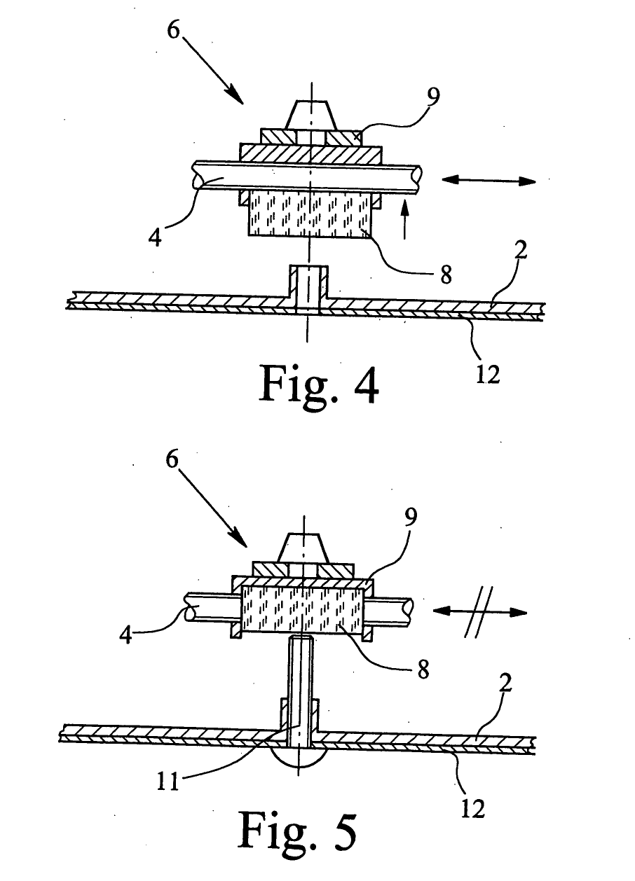

One alternative embodiment is shown in FIGS. 4 & 5. In this embodiment, the linkage 4 is a rod, while the attachment means 6 has a clip with a bottom part 8 and a top part 9. An auxiliary element 11 for closing the attachment means 6 is, in the present embodiment, a fastening screw. The fastening screw is arranged on the attachment means 6 such that, as it is screwed down it presses the bottom part 8 of the clip onto the top part 9 of the clip so that the linkage 4 is squeezed. It is advantageous if the motor vehicle door lock 2 is attached to the front sheet metal 12 of the motor vehicle door with the fastening screw at the same time. Here, the fastening screw should be one of the last (preferably the last fastening screw) between the front sheet metal 12 of the door and the motor vehicle door lock 2 so that shifting of the linkage 4 in the attachment means 6 is possible to the end of the installation process.

In another embodiment, the auxiliary element 11 can also be a lever. The auxiliary element 11 a lever is also used to close the attachment means 6. To do this, another element acts on the auxiliary element 11. The other element can in turn be a fastening screw, a latch, another lever or the like.

The installation of the motor vehicle door lock 2 on the motor vehicle door and the connection to the linkage 4 of the door handle 3 take place in several process steps. For installation purposes, when the attachment means 6 has been opened, the linkage 4 is moved relative to it, into a position in which first: the motor vehicle door lock 2 and the door handle 3 can be mounted on the motor vehicle door and then: the linkage 4 can be connected to the attachment means 6. Then the attachment means 6 is closed so that the linkage 4 is fixed relative to the attachment means 6. The closing of the attachment means 6 is provided in an especially suitable manner as closing of a clamping connection 7.

It is advantageous if a positive connection is achieved between the linkage 4 and the attachment means 6 when the attachment means 6 is closed. This can be accomplished, for example, in that in the closing process the inside thread of the attachment means 6 engages the outside thread of the linkage 4.

The attachment means 6 itself is advantageously a clip with a bottom part 8 and a top part 9. The closing of the attachment means 6 then comprises sliding the bottom part 8 of the clip onto the top part 9 of the clip, so that the linkage 4 is squeezed between the bottom part 8 of the clip and the top part 9 of the clip. Closing of the attachment means 6 takes place, in a preferred embodiment, when the motor vehicle door is closed for the first time. An auxiliary element 11 which is a pivotally mounted component, preferably the latch of the motor vehicle door lock, interacts with the attachment means 6 by means of two ramps 13, 14 such that the attachment means 6 is closed.

Alternatively, the closing of the attachment means 6 can however also take place by an auxiliary element 11 which is made as an attachment element, especially by a fastening screw. It is preferable here that the closing of the attachment means 6 takes placed while the fastening screw is being screwed in. The latter can, at the same time, perform another task, such as attachment of the motor vehicle door lock 2 to the motor vehicle door.

As another alternative, closing of the attachment means 6 can take place by an auxiliary element 11 which is a lever. To close the attachment means 6 the lever is actuated by another element, such as for example a fastening screw, the latch, another lever, or the like.

1. A motor vehicle door locking means for mounting on a motor vehicle door, the motor vehicle door locking means comprising:
a motor vehicle door lock having an attachment means;
a door handle; and
a linkage for a connecting the door handle to the motor vehicle door lock,
wherein the linkage is adapted to transmit actuating forces, created by actuation of the door handle, to the motor vehicle door lock, and
wherein the attachment means and the linkage is connected, relative to movements caused by actuation of the door handle, and
wherein the attachment means includes an opened position in which the linkage is freely moved in at least one direction relative to the attachment means, and a closed position in which the linkage is fixed relative to the attachment means with respect to movements caused by actuation of the door handle.

2. The motor vehicle door locking means as claimed in claim 1, wherein the linkage is located in the attachment means in the closed position.

3. The motor vehicle door locking means as claimed in claim 1, wherein the attachment means is a clip.

4. The motor vehicle door locking means as claimed in claim 1, wherein the linkage is a rod.

5. The motor vehicle door locking means as claimed in claim 1, wherein the attachment means, when the motor vehicle door lock has been installed in a motor vehicle door, is adapted to be placed into a closed position by a first-time closing of the motor vehicle door.

6. The motor vehicle door locking means as claimed in claim 1, wherein the motor vehicle door lock further comprises an auxiliary element and wherein the auxiliary element is adapted to place the attachment means into the closed position.

7. The motor vehicle door locking means as claimed in claim 6, wherein the auxiliary element is a pivotally supported component.

8. The motor vehicle door locking means as claimed in claim 7, wherein the auxiliary element is attached to a sheet metal panel of the door.

9. The motor vehicle door locking means as claimed in claim 7, wherein the auxiliary element comprises a ramp, wherein the attachment means comprises a ramp and wherein the ramps are arranged so as to interact when the auxiliary element turns to place the attachment means in the closed position.

10. The motor vehicle door locking means as claimed in claim 7, wherein the auxiliary element is adapted to rotate as the motor vehicle door is closing in an installed state of the motor vehicle door lock in the motor vehicle door.

11. The motor vehicle door locking means as claimed in claim 10, wherein the auxiliary element is a latch associated with the motor vehicle door lock.

12. The motor vehicle door locking means as claimed in claim 6, wherein the auxiliary element is an attachment element for attaching the motor vehicle door lock itself to the motor vehicle door.

13. A motor vehicle door lock, comprising:
an attachment means for a linking a door handle and a motor vehicle door lock via a linkage, wherein the linkage is connected to the attachment means relative to movements caused by actuation of the door handle,
wherein the attachment means includes an opened position in which the linkage is adapted to move freely in at least one direction relative to the attachment means, and a closed position in which the linkage is fixed relative to the attachment means, with respect to movements caused by actuation of the door handle.

14. The motor vehicle door lock as claimed in claim 13, further comprising:
an auxiliary element, wherein the auxiliary element is adapted to produce closing of the attachment means and wherein the auxiliary element is a pivotally supported component.

15. The motor vehicle door lock as claimed in claim 13, further comprising:
an auxiliary element, wherein the auxiliary element is adapted to produce closing of the attachment means and wherein the auxiliary element is an attachment element for attaching the motor vehicle door lock to the motor vehicle door.

16. A process for mounting a motor vehicle door locking means, a motor vehicle door lock, a door handle and a link between the door handle and the motor vehicle door lock, wherein the link is connected by an attachment means of the motor vehicle door lock, comprising the steps of:
placing the attachment means into an open position;
moving the linkage into a position in the attachment means in which the motor vehicle door lock and the door handle are fixed on the motor vehicle door, and
placing the attachment means into a closed position wherein the linkage is thus fixed in the attachment means.

17. A process as claimed in claim 16, further comprising:
placing the attachment means into the closed position by closing the motor vehicle door for the first time.

18. A process as claimed in claim 16, further comprising:
placing the attachment means into a closed position by use of an auxiliary element.

19. A process as claimed in claim 16, further comprising:
placing the attachment means into a closed position by use of an attachment element.

20. A process as claimed in claim 19, wherein the attachment means is placed into the closed position by attachment of the motor vehicle door lock to the motor vehicle door.

21. The process as claimed in claim 19, wherein a fastening screw is used as the attachment element.

22. The motor vehicle locking means of claim 12, wherein the auxiliary element is a fastening screw.
